(19) United States
(12) Patent Application Publication
(10) Pub. No.: US 2014/0033598 A1
(43) Pub. Date: Feb. 6, 2014

(54) INFLATABLE FISHING DEVICE

(71) Applicant: Dustin Anthony Camp, Lexa, AR (US)

(72) Inventor: Dustin Anthony Camp, Lexa, AR (US)

(21) Appl. No.: 13/958,314

(22) Filed: Aug. 2, 2013

Related U.S. Application Data
(60) Provisional application No. 61/678,641, filed on Aug. 2, 2012.

(51) Int. Cl. A01K 93/02

(52) U.S. Cl. CPC A01K 93/02
USPC 43/4.5; 43/17

(57) ABSTRACT

An inflatable fishing device. The inflatable fishing device may include an inflatable tube that may include an air fill and release port, and a fishing line. The inflatable tube may also include a handle. The fishing line may be segmented by a line adjuster. The inflatable tube rotates from a substantially horizontal position to a substantially vertical position when a fish has taken the bait that may be attached to the end of the fishing line by way of a swivel snap and hook.

### CROSS-REFERENCE TO RELATED APPLICATION

This application claims the benefit of U.S. provisional application No. 61/678,641, filed Aug. 2, 2012, the contents of which are herein incorporated by reference.

### BACKGROUND OF THE INVENTION

The present invention relates to fishing devices and, more particularly, to an inflatable fishing device with a line adjuster.

Jug fishing is a method of fishing that uses lines suspended from floating jugs to catch fish in lakes and rivers. Often a large number of jugs are used when jug fishing. Conventional jug fishing consists of a simple setup where lines are tied onto jugs and weights can be added to the line to keep the jug's location fixed. Many fish can be caught on jugs, but the main target of jug fishing is often catfish.

As the name implies, “jug fishing” traditionally uses jugs, or the like, for line suspension. Typical “jugs” include plastic 2 liter soda containers, or sections of foam “noodles”. While these “jugs” are inexpensive and buoyant, they are hard to transport and store because of size, slow to set up and retrieve, and can also be hard to see. In addition, the string is not adjustable and therefore tangles easily. Moreover, traditional jugs are imperfect insofar as it can be difficult to tell if a fish has been hooked.

As can be seen, there is a need for an inflatable fishing device that may clearly indicate that a fish is caught, has an adjustable line and is small and compact so that transport is simple.

### SUMMARY OF THE INVENTION

In one aspect of the present invention, an inflatable fishing device comprises; an inflatable tube having an outside surface, a top side, a bottom side, an upper section and a lower section, wherein the inflatable tube comprises a attachment point attached to the bottom side of the inflatable tube and an air fill and release port attached to the upper section of the inflatable tube; and a fishing line having a first segment having a top piece and a bottom piece and a second segment having a lower piece and an upper piece, wherein the top piece of the first section of the fishing line attaches to the attachment point of the inflatable tube.

In another aspect of the present invention, a method for jug fishing comprising the steps of; inflating an inflatable tube, the inflatable tube having an outside surface, a top side, a bottom side, an upper section and a lower section, wherein the inflatable tube comprises a attachment point attached to the bottom side of the inflatable tube and an air fill and release port attached to the upper section of the inflatable tube; providing a fishing line having a first segment having a top piece and a bottom piece and a second segment having a lower piece and an upper piece, comprising a swivel snap attached to the lower piece of the second segment of the fishing line; attaching the top piece of the first section of the fishing line to the attachment point of the inflatable tube; attaching a hook to the swivel snap; placing bait onto the hook; placing the inflatable tube, the fishing line, the swivel snap, hook and bait into a water source; waiting until the inflatable tube rotates to a vertical position signifying that a fish has taken the bait; and retrieving the inflatable tube and fishing line from the water.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a side elevation view of an exemplary embodiment of the present invention in use;

FIG. 3 is a side elevation view of an exemplary embodiment of the present invention in use;

FIG. 4 is a detail perspective view of an exemplary embodiment of the present invention; and

FIG. 5 is an elevation view of a frame of a line adjuster of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an inflatable fishing device. The inflatable fishing device may include an inflatable tube that may include an air fill and release port, and a fishing line. The inflatable tube may also include a handle. The fishing line may be segmented by a line adjuster. The inflatable tube rotates from a substantially horizontal position to a substantially vertical position when a fish has taken the bait that may be attached to the end of the fishing line by way of a swivel snap and hook.

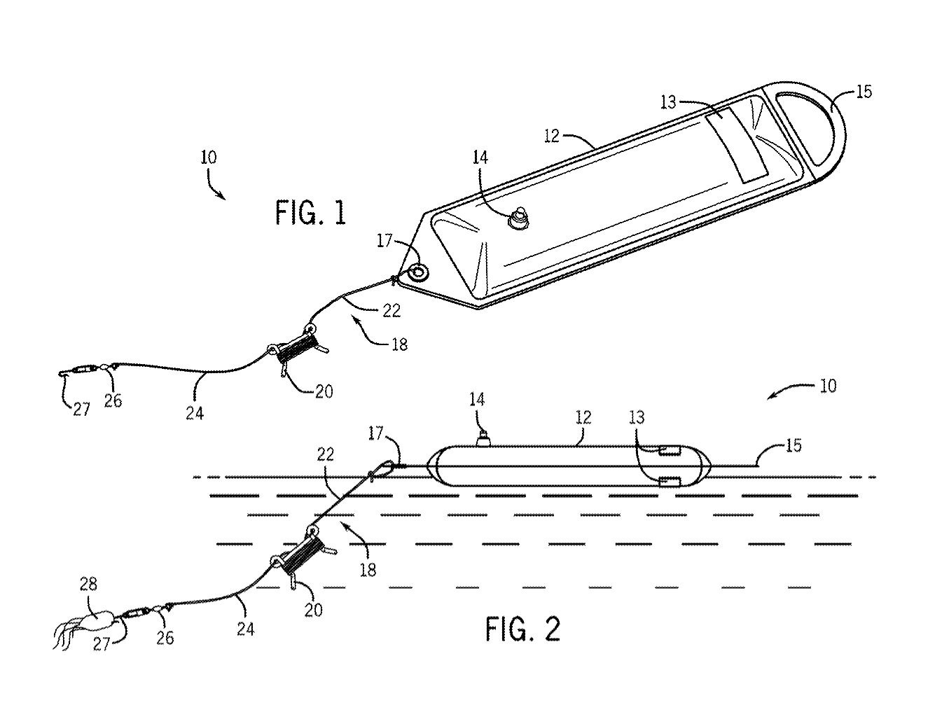

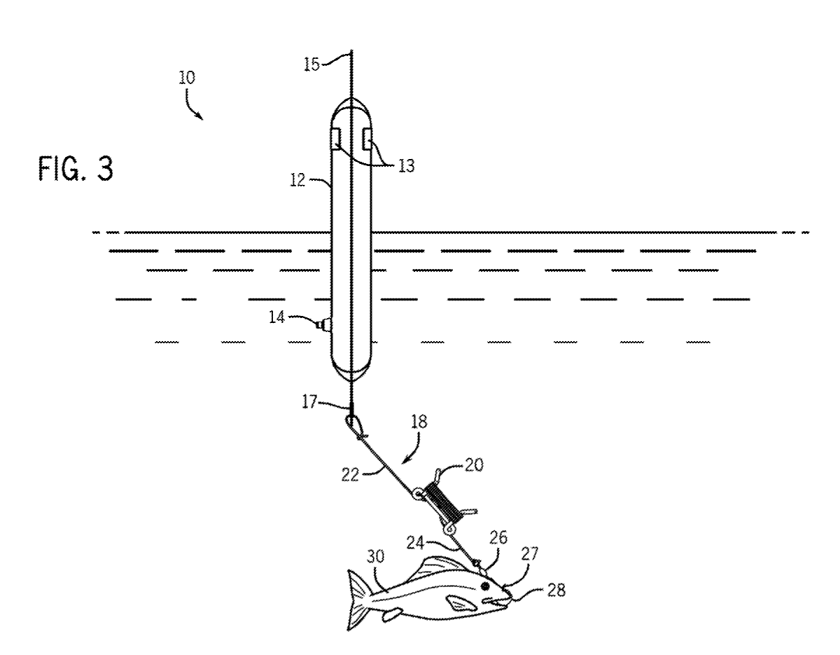

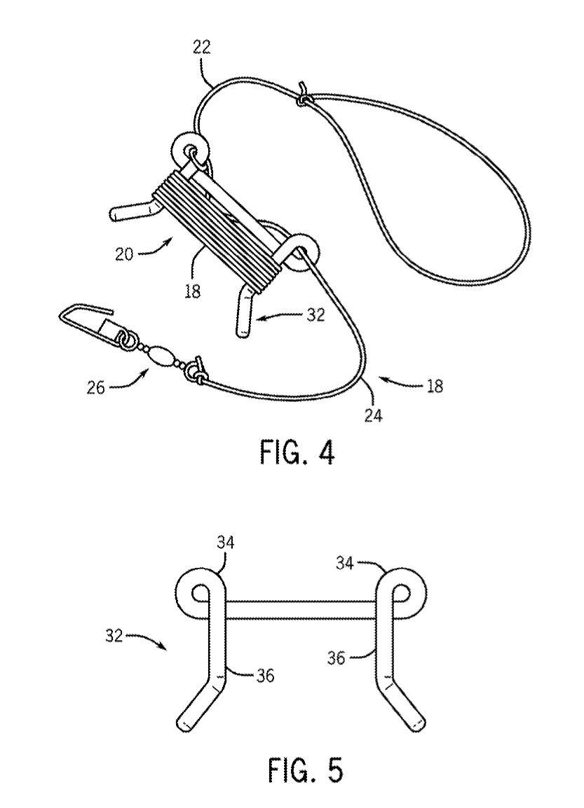

Referring now to FIGS. 1 through 5, an inflatable fishing device 10 may include an inflatable tube 12. The inflatable tube 12 may be elongated with a handle 15 on one end, have at least one strip of reflective tape 13 attached to the outside surface of the inflatable tube 12. The inflatable tube 12 may further include an air fill and release port 14. A fishing line 18 may be attached to the inflatable tube 12 by way of an attachment point 17 such as a ring, grommet or the like. The fishing line 18 may be separated into two segments, a first segment of line 22 and a second segment of line 24 by a line adjuster 20. At the end of the fishing line 18 may be a swivel snap 26 attached to a hook 27.

The inflatable fishing device 10 may be used in order to catch fish 30 that may be in a body of water. In certain embodiments, the inflatable tube 12 may have a rectangular shape prior to being inflated. The inflatable tube 12 may have a top side, a bottom side, an upper section and a lower section. On the top side of the inflatable tube 12 may be a handle 15. The handle 15 may be round in shape. The shape of the inflatable tube 12 may be so that a side with the broadest surface area may sit against the surface of the water so that the inflatable tube 12 may be sitting on top of and horizontal with the surface of the water while not engaged by a fish 30.

Along the upper section of the inflatable tube 12 may be the air fill and release port 14. The air fill and release port 14 may be used for inflating and deflating the inflatable tube 12. The air fill and release port 14 may be capped in order to keep the inflatable tube 12 inflated.

In certain embodiments, at least one strip of reflective tape 13 may be attached to the inflatable tube 12. For example, the reflective tape 13 may be along the upper section and/or lower section of the inflatable tube 12. In certain embodiments, at least one strip of reflective tape 13 may be attached to the handle 15 as well. The at least one strip of reflective tape 13 allows the user to identify the inflatable tube 12 on the water.

Along the bottom side of the inflatable tube 12 may be an attachment point 17. A fishing line 18 may be attached to the attachment point. In certain embodiments, the attachment point 17 may include, but is not limited to, a ring, grommet and the like.

In certain embodiments, the fishing line 18 may be separated into two segments, the first segment 22 and the second segment 24. The first segment 22 and the second segment 24 may be separated by the line adjuster 20. The line adjuster 20 may include a line adjuster frame 32 that may have a top portion and a bottom portion, at least one line adjuster loop 34 formed on the top portion of the line adjuster frame 32 and at least one line adjuster leg 36 formed on the bottom portion of the line adjuster frame 32. As illustrated in FIG. 5, the line adjuster may include a pair of loops 34 and a pair of legs 36.

The first segment 22 of the fishing line 18 may have a top end and a bottom end. The top end of the first segment 22 may be connected to the attachment point 17 on the inflatable tube 12. The bottom end of the first segment 22 may be connected to the line adjuster 20 through at least one loop 34. The second segment 24 may have a top end and a bottom end. The top end of the second segment 24 may be connected to the line adjuster 20 through at least one loop 34. The fishing line 18 may be wrapped around the at least one line adjuster leg 36 to tighten or loosen the fishing line 18. The bottom end of the second segment 24 may be attached to a swivel snap 26. The swivel snap 26 may be connected to a hook 27. The hook 27 may be used to secure bait 28 for fishing.

A method of using the inflatable fishing device may include the following. The inflatable fishing device may be easily stored on a boat or other location while not in use. An individual, when ready to use the device, may take the present invention out of storage. With the inflatable tube exposed, the individual may add air to the inflatable tube by opening the air fill and release port and adding air. Once the inflatable tube is at a desirable level, the air fill and release port may be closed. The individual may connect the fishing line to the attachment point and to the line adjuster, adjusting the fishing line to the desired length by wrapping excess line around the line adjuster passing through the at least one line adjuster loop. Bait may be attached to the hook, the line may be weighted and the individual may then place the inflatable tube on the water. The inflatable tube may lie flat along the water while the fishing line may sink towards the bottom of the water. The inflatable tube may be substantially horizontal relative to the water while there is no contact with fish. The individual may then monitor the inflatable tube for an indication that a fish has taken the bait. When a fish sets the hook, by going after the bait, the inflatable tube may go from the substantially horizontal position, to a substantially vertical position. The vertical position may notify the fisherman that a fish is on the line. Being made out of bright colors and reflective tape attached to the inflatable tube, the inflatable tube may catch the attention of the individual as well to let the individual know a fish is on the line, especially during night fishing. The present device may be easy to retrieve, by simply grabbing the handle of the inflatable holder and pulling the present device out of the water. If necessary, the line adjuster may allow for the line, and therefore, the hook with the bait, to be at various levels under the water. The adjustable level of the line may prevent tangling of the line and catching on obstacles within the water. The adjustable level may also allow for fishing at different depths, which may provide opportunity to catch different types of fish.

Components such as the inflatable tube may be made from a polymer such as plastic and the like. The line adjuster may be made from a metal and the like. The present device may be part of a kit that may store multiple devices and take up a small amount of space.

It should be understood, of course, that the foregoing relates to exemplary embodiments of the invention and that modifications may be made without departing from the spirit and scope of the invention as set forth in the following claims.

What is claimed is:

1. An inflatable fishing device comprising:
an inflatable tube having an outside surface, a top side, a bottom side, an upper section and a lower section, wherein the inflatable tube comprises a attachment point oriented near the bottom side of the inflatable tube and an air fill and release port attached to the inflatable tube; and
a fishing line having a top end and a bottom end wherein the top end of the fishing line attaches to the inflatable tube at the attachment point.

2. The inflatable fishing device of claim 1, wherein the inflatable tube is in a rectangular shape.

3. The inflatable fishing device of claim 1, wherein the attachment point is a grommet.

4. The inflatable fishing device of claim 1, further comprising a handle at the top side of the inflatable tube.

5. The inflatable fishing device of claim 1, further comprising a line adjuster attached to the fishing line, wherein the line adjuster comprises a line adjuster frame having a top portion and a bottom portion, wherein the line adjuster frame comprises at least one line adjuster loop formed on the top portion of the line adjuster frame and at least one line adjuster leg formed on the bottom portion of the line adjuster frame.

6. The inflatable fishing device of claim 5, wherein the fishing line comprises a first segment having a top end and a bottom end and a second segment having a top end and a bottom end, wherein the bottom end of the first segment of the fishing line and the top end of the second segment of the fishing line are removably attachable to the at least one line adjuster loop of the line adjuster.

7. The inflatable fishing device of claim 1, further comprising a swivel snap attached to the bottom end of the fishing line.

8. The inflatable fishing device of claim 7, further comprising a hook attached to the swivel snap.

9. The inflatable fishing device of claim 5, wherein the at least one line adjuster loop comprises two line adjuster loops.

10. The inflatable fishing device of claim 5, wherein the at least one line adjuster leg comprises two line adjuster legs.

11. The inflatable fishing device of claim 1, further comprising at least one strip of reflective tape attached to the outside surface of the inflatable tube.

12. A method for jug fishing comprising the steps of:
inflating an inflatable tube, the inflatable tube having an outside surface, a top side, a bottom side, an upper section and a lower section, wherein the inflatable tube comprises an attachment point at to the bottom side of the inflatable tube and an air fill and release port attached to the inflatable tube;
providing a fishing line having a top end and a bottom end, comprising a swivel snap attached to the bottom end of the fishing line;
attaching the top piece of the first section of the fishing line to the attachment point of the inflatable tube;
attaching a hook to the swivel snap;
placing bait onto the hook;
placing the inflatable tube, the fishing line, the swivel snap, hook and bait into source body of water; and
retrieving the inflatable tube and fishing line from the water once the inflatable tube rotates to a vertical position, indicating a fish has been hooked.

13. The method of claim 12, further including the step of adjusting the fishing line by using a line adjuster prior to placing into a water source.
